(19) United States
(12) Patent Application Publication
(10) Pub. No.: US 2008/0014499 A1
(43) Pub. Date: Jan. 17, 2008

(54) Prismatic Battery With Novel Intercell Connection

(75) Inventor: Pui Tsang Peter Ling, Hksar (CN)

Correspondence Address: BUCHANAN, INGERSOLL & ROONEY PC, POST OFFICE BOX 1404, ALEXANDRIA, VA, 22313-1404, US

(73) Assignee: Sylva Industries Limited, New Territories (CN)

(21) Appl. No.: 11/597,922

(22) PCT Filed: Jun. 2, 2005
(86) PCT No.: PCT/IB05/01551

§ 371 Date: Nov. 29, 2006

(30) Foreign Application Priority Data
Jun. 2, 2004 (CN) 04103954.4

(51) Int. Cl. H01M 2/00; H01M 6/00

(52) U.S. Cl. 429/163; 29/623.1

(57) ABSTRACT

A prismatic battery comprising a battery housing and a plurality of electrode plate cell groups, each said electrode plate cell group comprises a positive current collector and a negative current collector which are connected respectively to a positive electrode plate group and a negative electrode plate group, said battery housing comprises a plurality of cell compartments which are adapted for receiving said plurality of electrode plate cell groups, wherein, adjacent cell compartments being electrically connected by a pair of conductive bridging members which are disposed respectively in said adjacent cell compartments and said bridging members being connected electrically across said adjacent cell compartments by a plurality of electrical conductors which extend across said adjacent cell compartments, each said bridging member being electrically connected to a corresponding current collector at more than one locations.

### FIELD OF THE INVENTION

This invention relates to prismatic batteries and, more particularly, to prismatic batteries comprising a plurality of prismatic battery cells. More specifically, although of course not solely limited thereto, this invention relates to rechargeable batteries with prismatic cells.

### BACKGROUND OF THE INVENTION

Batteries and battery cells with a general prismatic shape are commonly known respectively as prismatic batteries and prismatic battery cells. Although most prismatic batteries and batteries cells have a rectangular or circular cross section, prismatic batteries can be made with any appropriate cross section with loss of generality. A prismatic battery or battery module is typically constructed from a plurality of cells. Each cell is formed from a positive cell plate group and a negative cell plate group. Each cell plate group comprises a plurality of electrode plates which are stacked in parallel. The positive and negative electrode cell plate groups are connected respectively to the positive and negative current collectors. Each battery cell is then connected to an adjacent cell via the current collectors and/or the respective contact terminals. A sub-assembly of the electrode cell plate groups and the current collectors is usually sealed inside a prismatic housing and the packaged battery cell has an overall prismatic shape and hence the calling “prismatic battery cells”.

A prismatic battery typically comprises a plurality of prismatic battery cells which are stacked in parallel and bound together and the resulting battery has an overall prismatic shape. It should be appreciated that the term “prismatic battery cell” refers generally to battery cells comprising a plurality of electrode plates which are stacked in parallel and which are electrically connected together along their corresponding lateral sides. This is distinguished to a cylindrical battery cell in which each electrode group comprises an electrode plate which is helically or spirally coiled into a plurality of substantially cylindrical surfaces.

In this specification, the term “prismatic battery cell” is used to describe a category of batteries and is not intended to restrict or limit to battery cells of an exact prismatic shape. More particularly, this term is used to describe a battery cell having positive and negative electrode plate groups in which each one of the electrode plate groups comprises a plurality of electrode plates which are stacked in parallel. The electrode plates of an electrode plate group are electrically connected together on one lateral side and are non-electrically bound on the other, opposite, side. The electrode plates of the positive and the negative electrode plate groups of a battery cell are alternately stacked with respect to each other so that, except for the outermost electrode plates, an electrode cell plate of one electrode plate group is sandwiched between a pair of electrode plates of the electrode plate group of the opposite polarity. In addition, separators are disposed between an adjacent pair of positive and negative electrode plates in the manner commonly known by skilled persons or as appropriate. It will be appreciated that while it is common for prismatic battery cells to have rectangular electrode plates, it is neither essential nor strictly necessary that the electrode plates are rectangular.

Batteries with prismatic cells are used in many high current applications or in applications in which a high power density is required. For example, rechargeable prismatic batteries such as Nickel Metal Hydride (NiMH) batteries have been widely used as power sources for driving electrical vehicles (EV) or hybrid electrical vehicles (HEV) because of their superior energy density characteristics.

In general, electrical energy is produced by chemical reaction between the positive and negative electrode plate groups in the presence of a liquid or fluid type electrolyte and the electrical energy thus generated is delivered to the load first via the current collectors and then through the contact terminals. To meet appropriate power rating requirements, a plurality of battery cells are connected to form a battery unit or a battery module. The battery cells are then connected together by welding the upper free ends of the current collector plates of adjacent electrode plate groups. In many batteries, the contacts between the electrode plate groups are an important source of internal resistance of a battery. A high internal resistance means high energy wastage as well as introducing heat dissipation problems. Such energy wastage and heat generation are particularly undesirable for high current applications such as electrical vehicles or hybrid electrical vehicles since the efficiency will be adversely affected and the internal heat needs to be dissipated to avoid premature failure or battery damage due to over-heating. Hence, it is desirable if prismatic batteries with improved inter-cell connection can be provided to alleviate shortcomings of conventional prismatic batteries.

In addition, as the compactness of a battery will affect the energy-to-volume ratio of batteries and there is an increasing demand for batteries with a high energy density per unit volume, it will be beneficial, but of course not essential, if the improved prismatic batteries also have a good spatial utilization to enhance power density.

### OBJECT OF THE INVENTION

Accordingly, it is an object of the present invention to provide improved prismatic batteries, especially prismatic batteries with improved intercell connection to alleviate shortcomings of conventional intercell connections. At a minimum, it is an object of this invention to provide the public with a useful choice.

### SUMMARY OF THE INVENTION

According to the present invention, there is provided a prismatic battery comprising a battery housing and a plurality of electrode plate groups, each said electrode plate group comprises a positive current collector and a negative current collector which are connected respectively to a positive electrode plate group and a negative electrode plate group, said battery housing comprises a plurality of cell compartments which are adapted for receiving said plurality of electrode plate groups, wherein, adjacent cell compartments being electrically connected by a pair of conductive bridging members which are disposed respectively in said adjacent cell compartments and said bridging members being connected electrically across said adjacent cell compartments by a plurality of electrical conductors which extend across said adjacent cell compartments, each said bridging member being electrically connected to a corresponding current collector at more than one locations.

Preferably, each said cell compartment being substantially rectangular, the partitioning walls between adjacent cell compartments being also substantially rectangular, each said bridging member being substantially rectangular and with a shape similar to and dimensions comparable with said partitioning wall.

Preferably, said current collectors and said bridging members being of similar shape and dimensions.

Preferably, said pair of bridging members being welded together at a plurality of locations, whereby electrical interconnection between adjacent cell compartments are formed, said partitioning walls being sandwiched between said pair of bridging members and the interconnection between adjacent bridging members being surrounded by sealing means, whereby sealed electrical interconnections between adjacent cell compartments are formal.

Preferably, said bridging member and a corresponding current collector being electrically connected respective near their upper and lower ends.

Preferably, each said bridging member comprising an elongated metallic plate which is performed with a plurality of protruded portions, said protruded portions being spaced corresponding to said interconnection apertures and each protruded portion being dimensioned to be surrounded by the corresponding interconnection aperture, the protruded portions on corresponding bridging members being adapted so that when they are welded together, sealing means disposed between said bridging members will seal said interconnection apertures from the cell compartments.

Preferably, each said cell compartment comprises an upper end and a lower end, a corresponding pair of bridging member and current collector being welded together near said upper and lower ends, said upper and lower ends of said cell compartment being sealed after welding of said bridging member and current collector.

In addition, this invention also describes a method of making a prismatic battery, comprising the steps of:
forming a battery housing with a plurality of cell compartments which are defined by partitioning walls on each of which more than one interconnection apertures are formed,
placing a pair of conductive bridging members into said cell compartments and joining said pair of bridging members so that a partitioning wall is sandwiched between said pair of bridging members with said interconnection apertures sealed,
placing an electrode plate group inside said cell compartment with the current collectors aligned with the corresponding bridging members,
welding a corresponding current collector and a corresponding bridging member together at more than one locations,
filling said battery with an electrolyte and
sealing said battery housing.

In addition, the method further comprising the step of sealing the lower end of the cell compartments before filling said battery with an electrolyte.

### BRIEF DESCRIPTION OF THE DRAWINGS

Preferred embodiments of the present invention will be explained in further detail below by way of examples and with reference to the accompanying drawings, in which:

FIG. 1 is a perspective view showing the external view of a preferred embodiment of a prismatic battery of the present invention,

FIG. 2 shows a partially exploded view of a moulded battery housing of the battery of FIG. 1

FIG. 3 shows the battery housing of FIG. 2 with pairs of conductive bridging members in the course of assembly,

FIG. 4 shows the housing of FIG. 2 with bridging members assembled,

FIG. 4A shows an enlarged partial longitudinal cross-sectional view taken along a partitioning wall of a cell compartment of the housing of FIG. 4,

FIG. 5 illustrates an electrode cell group in the course of being inserted into a cell compartment of FIG. 4,

FIG. 6 shows a partially assembled prismatic battery module with terminal connectors in the course of being assembled,

FIG. 7 shows the sealing of the battery housing after the electrode plate groups are in place and terminal connectors are assembled, and

FIG. 8 shows a partially exploded view of the assembled prismatic battery of FIG. 1.

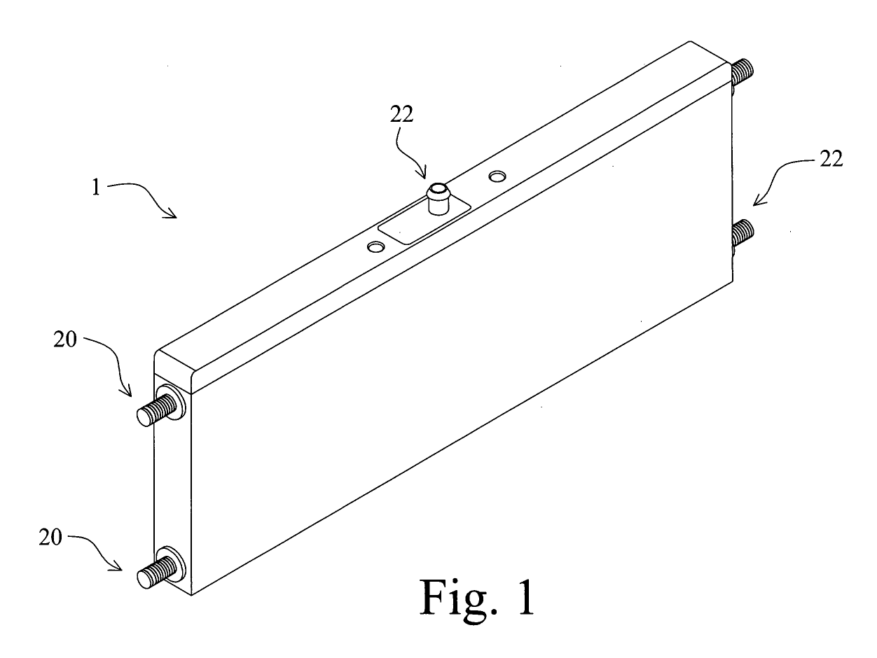

### DETAILED DESCRIPTION OF THE PREFERRED EMBODIMENTS

In the specification below, although reference is made to a Nickel-Metal-Hydride (NiMH) battery as a convenient illustration example since Nickel-Metal-Hydride rechargeable batteries have been widely used and are known to have a superior power density characteristic, reasonably priced and with a reasonable battery life, it would be appreciated by a skilled person that the principles described in the present specification apply mutantis mutandis to other types of prismatic batteries, especially rechargeable prismatic batteries, comprising battery cells having electrode plates which are stacked in parallel, without loss of generality.

Typically, a battery module comprises a plurality of battery cells which are connected together to meet the appropriate power rating requirements. Each battery cell comprises an electrode plate group 10 which is formed by a stack of parallely interposed positive and negative electrode plates with separators interposed between adjacent electrode plates (collectively, an “electrode plate group”). An electrode plate group comprises a positive electrode plate group and a negative electrode plate group which are separated by separators. A positive electrode plate group comprises a plurality of positive electrode plates with lead portions connected to a positive current collector. A negative electrode plate group comprises a plurality of negative electrode plates with lead portions connected to a negative current collector. The positive and negative electrode plate groups together constitute the electrode plate group of a prismatic cell. The electrode plate groups are arranged so that positive electrode plates and negative electrode plates are interleaved with a separator interposed between each pair of positive and negative electrode plates.

Each of the electrode plates includes an active region and a lead region. The corresponding active regions of a pair of positive and negative plates are substantially overlapping and react in the presence of an electrolyte to convert chemical energy into electrical energy. The active regions of the electrode plates of a typical prismatic battery cell are substantially rectangular with one of the longer or longitudinal sides adjacent the lead portion. The lead portion is typically elongated and is of substantially the same length as the longitudinal side of the active region as well as being substantially rectangular for maximum efficiency. Of course, the lead portion can be shorter or longer. The rectangular active regions of the electrode plates are usually formed from the same base material and both the active region and the lead portion have substantially the same length. Of course, it should be appreciated that while active regions are usually rectangular, it is not strictly necessary so and active regions of other shapes can be used without loss of generality.

In a typical Nickel-Metal-Hydride rechargeable battery, the active regions of the positive electrode plates are made of a nickel-foamed metal coated with nickel hydroxide. The active regions of the negative electrode plates are made of a nickel punched metal sheet coated with negative electrode constituting materials such as a hydrogen-absorbing alloy. The electrode plates are typically very thin to reduce material costs and weight since the electricity generating reaction is surface in nature. Current collectors 11 are usually nickel-plated copper or steel for good thermal and electrical conductivity. For prismatic battery cells in which the electrode plates are connected to the current collectors by electronic beam welding or carbon dioxide laser welding, the current collectors are typically thin nickel-plated plates since the actual welding junction is behind the approaching surface of the welding source.

In forming the electrode plate groups 10, lead portions of the electrode plates are first bundled together. Bundling in the present context including but not limited to the pressing, packing, gathering, welding or fastening together of the respective lead portions of the electrode plate groups. The bundled lead portions may then be maintained in form by soldering, welding or mechanical fastening means such as riveting. Furthermore, before the lead portions are bundled together, the electrode groups are usually already in an interleaving configuration with adjacent electrode plates of an opposite polarity in a closely packed relationship.

After the electrode plates have been bundled together, they are sub-assembled with the current collectors and the contact terminals. The sub-assembly will then be inserted into a prismatic battery housing and adjacent battery cells are connected together to form a battery module.

Referring to the Figures, a prismatic battery module 1 comprises a plurality of battery cells which are connected together. Each battery cell comprises an electrode plate group 10 with positive and negative current collectors 11. Each electrode plate group 10 is inserted into a cell compartment 12 of the battery housing 13 so that individual cell groups are separated from each other and are electrically connected via their respective current collectors 11.

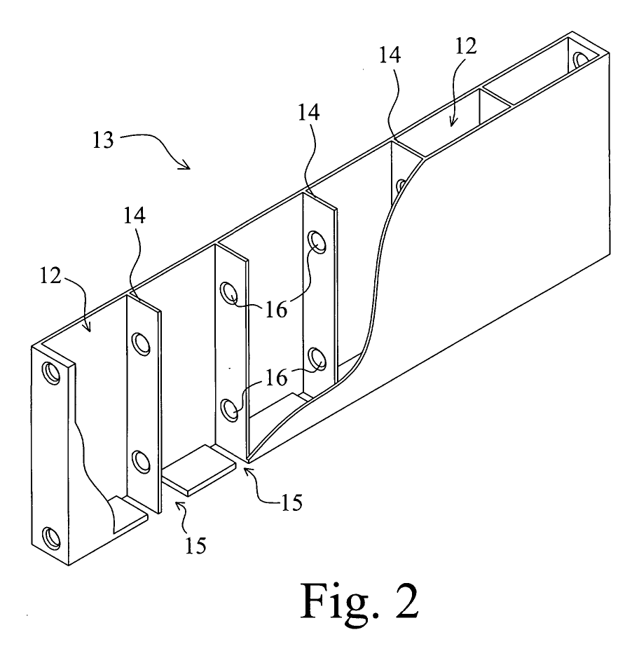

The battery housing 13 is usually moulded from hard plastics or resins and is preformed into a plurality of cell compartments 12 with a plurality of partitioning walls 14 separating adjacent cell compartments. As is more particularly shown in FIG. 2, each cell compartment 12 is substantially rectangular with substantially rectangular partitioning walls 14 defining the lateral limits of each cell compartment. Thus, the housing 13 is substantially rectangular and comprising a plurality of rectangular cell compartments with parallel partitioning walls. The lower end of each cell compartment is partially opened with apertures 15 formed adjacent to each partitioning wall to facilitate welding or soldering between a corresponding pair of a bridging member and a current collector to be explained below. The upper end of the cell compartments is fully opened and will be covered by a top cover when the assembly is nearly complete. Interconnection apertures 16 are formed near the upper and lower ends of the partitioning walls 14 to provide a guide for interconnection between an adjacent pair of bridging members also to be explained below.

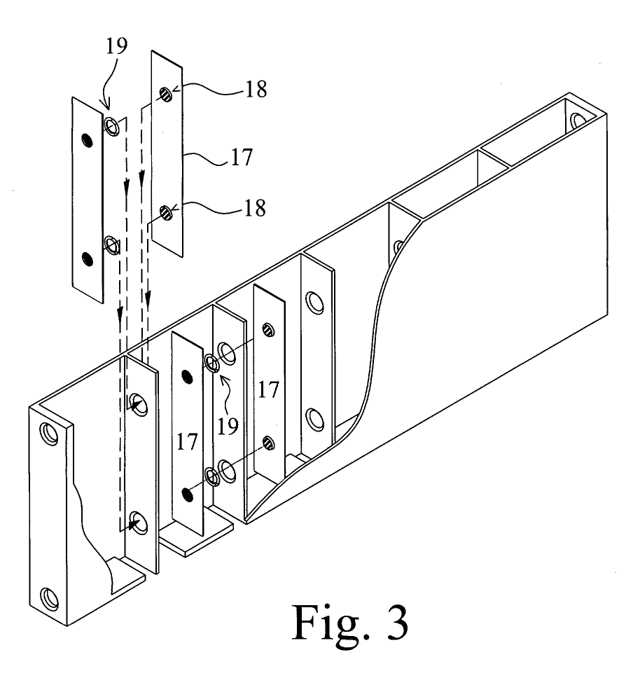

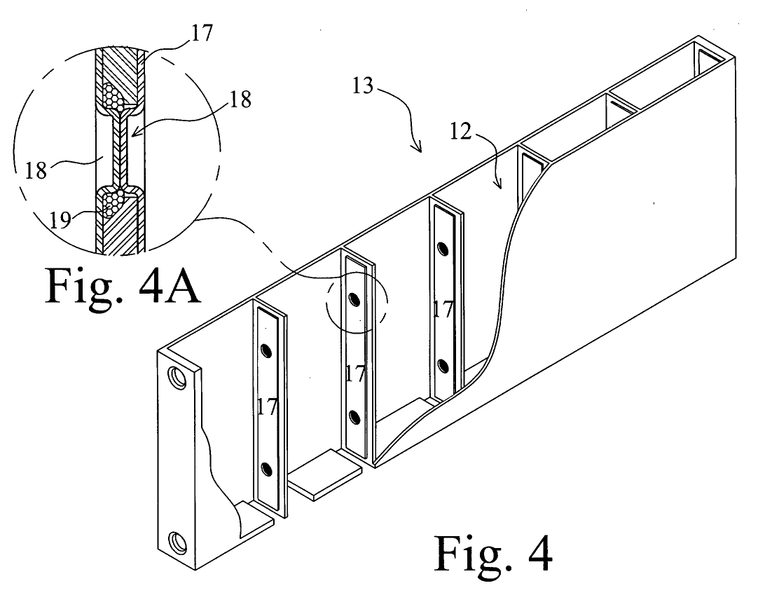

Referring to FIG. 3, the assembling of a pair of conductive bridging members of a partitioning wall of a cell compartment is illustrated. Each of the bridging member 17 comprises a rectangular metallic plate made of a material similar to the material of the current collectors. A plurality of protruding portions 18 are formed on the material bridging member at locations corresponding to the locations of the interconnection apertures 16. The elevation of the protruding portions above the general plane of the metallic plate of the bridging member 17 is designed so that when a corresponding pair of bridging members are placed together with the partitioning wall sandwiched between them, the elevated ends of the corresponding protruding portions will be in contiguous contact for easy welding. The protruding portion can be formed by stamping or pressing of a metallic plate or other appropriate shape-forming process. In order to ensure good fluid sealing between adjacent cell compartments, sealing means, for example, sealing rings or collars 19, are inserted between an adjacent pair of bridging members and surrounding the protruding portions so that when the protruding portions of an adjacent pair of bridging members are welded together, the sealing means will operate to seal the interconnection apertures so that electrolyte will not flow from one cell compartment to another. High temperature rubber or silicone are examples of suitable materials to form the sealing rings. To form intercell electrical connections, the pair of bridging members are positioned so that the protruding portions are aligned with interconnection apertures with the sealing means disposed between the partitioning wall and a bridging member. The protruding portions are then welded together while the bridging members are being pressed together in order to form an effective sealing between adjacent cell compartment as shown in FIG. 4.

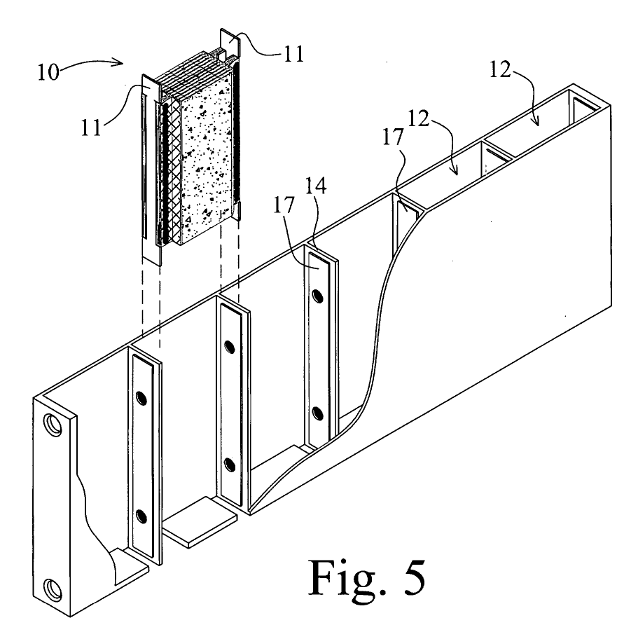

After the bridging members have been mounted onto the moulded plastic battery housing, the electrode plate groups 10 are inserted into the cell compartment 12 as shown in FIG. 5. To facilitate good welding, the electrode plate groups are dimensioned so that the current collectors are closely fitted within the lateral limits of the cell compartment, as defined by the bridging members which form the lateral limits of the partly-assembled battery housing. The current collectors are then welded with the bridging members. In order to reduce contact resistance between adjacent cells or electrode plate groups, each current collector and bridging member pair is welded at more than one locations. In the preferred exemplary electrode plate groups as shown in the Figures, each current collector extends beyond the upper and lower ends of the electrode plates so that the protruding upper and lower ends of the current collectors can be welded onto the corresponding bridging member by, for example, metal or other appropriate welding methods. As metal welding can be very well controlled nowadays, the protrusion of the current collectors beyond the main body of the electrode plate groups can be very small, for example, in the range of a few millimetres such as 2 to 3 mm, the space inside the cell compartment can be maximally utilized for maximal power density. As the upper end of the cell compartment is fully opened, welding between the current collector and the bridging member can be performed from the upper end of the cell compartment. To facilitate welding between the lower ends of the current collector and the bridging member, apertures 15 were deliberately formed at the lower end of the cell compartment adjacent to the lower end of the partitioning wall. Consequently, welding heads can access the lower end of the current collector for convenient metal welding. After welding has been completed, the lower end of the cell compartment is sealed, for example, by plastic welding such as heat-sealing, laser diode welding or ultrasonic welding of plastic patches 23. To facilitate reliable and convenient sealing of the bottom of the cell compartments, the bottom of the cell compartments comprises a moulded portion which extend between the front and rear sides of the housing.

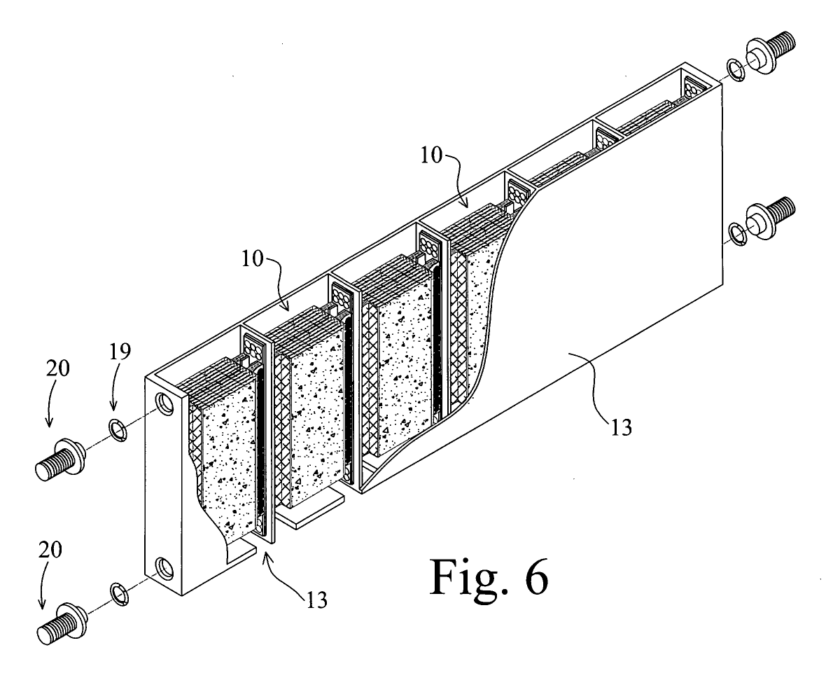

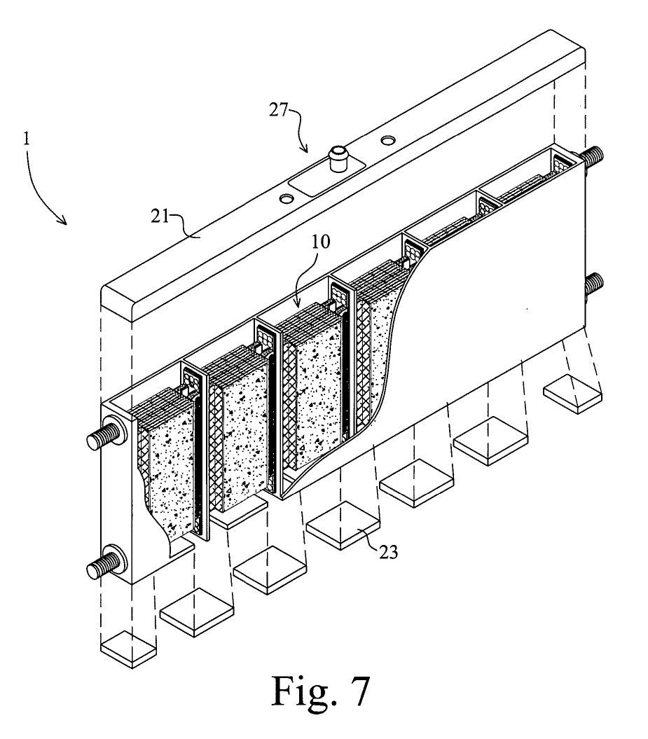

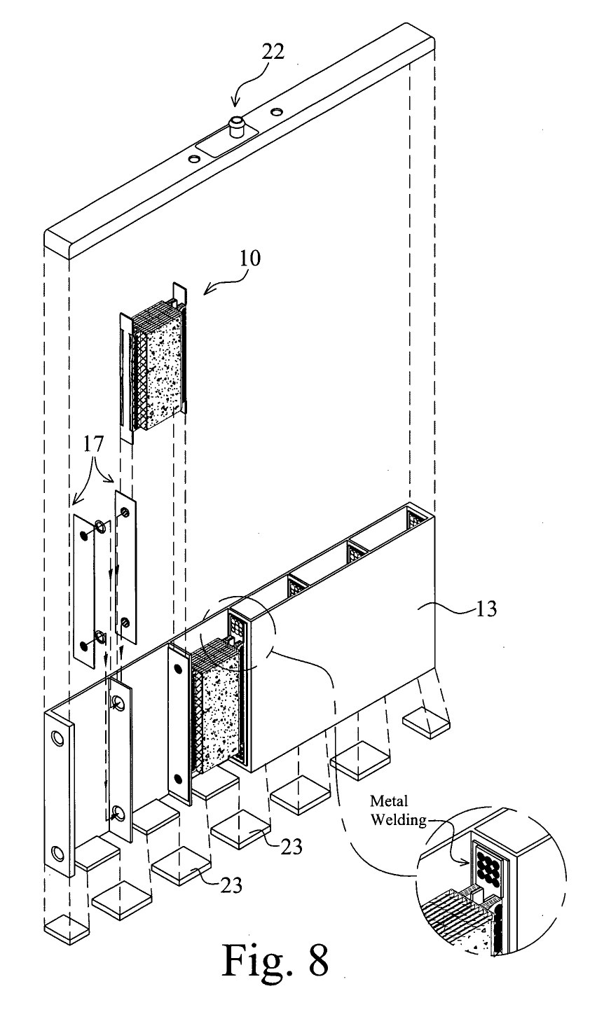

To provide interfacing means to facilitate for external electrical connection, terminal connectors 20 are connected to the respective current collectors. As shown in FIG. 6, a pair of terminal connectors 20 are connected to each stand alone current collector at the extreme and of the cell compartment. The pair of terminal connectors 20 provide parallel connection from the current collector to reduce contact resistance between the current collector and the external electrical connection. After the terminal connectors have been connected with the current collectors, the lower end of the cell compartments have been sealed, and the cell compartments have been filled with electrolyte, the upper end of the cell compartments is sealed with a top cover 21. A safety vent 22 is provided on the top cover to relieve excessive pressure. It will be appreciated that, by providing a pair of bridging members for making intercell electrical connection and then by welding the current collectors to the bridging members at more than more locations, intercell contact resistance can be substantially reduced, thereby enhancing the performance of a prismatic battery module. Furthermore, by providing a moulded battery housing with initially opened upper and lower ends of cell compartments, welding between the current collectors and the corresponding bridging members are made easier for enhanced productivity and reliability.

While the present invention has been explained by reference to the preferred embodiments described above, it will be appreciated that the embodiments are illustrated as examples to assist understanding of the present invention and are not meant to be restrictive on the scope and spirit of the present invention. The scope of this invention should be determined from the general principles and spirit of the invention as described above. In particular, variations or modifications which are obvious or trivial to persons skilled in the art, as well as improvements made on the basis of the present invention, should be considered as falling within the scope and boundary of the present invention.

Furthermore, while the present invention has been explained by reference to a rectangular prismatic battery, it should be appreciated that the invention can apply, whether with or without modification, to other prismatic batteries without loss of generality.

1. A prismatic battery comprising a battery housing and a plurality of electrode plate groups, each said electrode plate group comprises a positive current collector and a negative current collector which are connected respectively to a positive electrode plate group and a negative electrode plate group, said battery housing comprises a plurality of cell compartments which are adapted for receiving said plurality of electrode plate groups, wherein, adjacent cell compartments being electrically connected by a pair of conductive bridging members which are disposed respectively in said adjacent cell compartments and said bridging members being connected electrically across said adjacent cell compartments by a plurality of electrical conductors which extend across said adjacent cell compartments, each said bridging member being electrically connected to a corresponding current collector at more than one locations.

2. A prismatic battery according to claim 1, wherein each said cell compartment being substantially rectangular, the partitioning walls between adjacent cell compartments being also substantially rectangular, each said bridging member being substantially rectangular and with a shape similar to and dimensions comparable with said partitioning wall.

3. A prismatic battery according to claim 2, wherein said current collectors and said bridging members being of similar shape and dimensions.

4. A prismatic battery according to claim 3, wherein said pair of bridging members being welded together at a plurality of locations, whereby electrical interconnection between adjacent cell compartments are formed, said partitioning walls being sandwiched between said pair of bridging members and the interconnection between adjacent bridging members being surrounded by sealing means, whereby sealed electrical interconnections between adjacent cell compartments are formal.

5. A prismatic battery according to claim 4, wherein said bridging member and a corresponding current collector being electrically connected respective near their upper and lower ends.

6. A prismatic battery cell according to claim 4, wherein each said bridging member comprising an elongated metallic plate which is performed with a plurality of protruded portions, said protruded portions being spaced corresponding to said interconnection apertures and each protruded portion being dimensioned to be surrounded by the corresponding interconnection aperture, the protruded portions on corresponding bridging members being adapted so that when they are welded together, sealing means disposed between said bridging members will seal said interconnection apertures from the cell compartments.

7. A prismatic battery cell according to claim 2, wherein each said cell compartment comprises an upper end and a lower end, a corresponding pair of bridging member and current collector being welded together near said upper and lower ends, said upper and lower ends of said cell compartment being sealed after welding of said bridging member and current collector.

8. A method of forming a prismatic battery module of claim 1, comprising the steps of:
forming a battery housing with a plurality of cell compartments which are defined by partitioning walls on each of which more than one interconnection apertures are formed,
placing a pair of conductive bridging members into said cell compartments and joining said pair of bridging members so that a partitioning wall is sandwiched between said pair of bridging members with said interconnection apertures sealed,
placing an electrode plate group inside said cell compartment with the current collectors aligned with the corresponding bridging members,
welding a corresponding current collector and a corresponding bridging member together at more than one locations,
filling said battery with an electrolyte and
sealing said battery housing.

9. A method of making a prismatic battery according to claim 8, further comprising the step of sealing the lower end of the cell compartments before filling said battery with an electrolyte.
